(19) United States
(12) Patent Application Publication
(10) Pub. No.: US 2017/0184248 A1
(43) Pub. Date: Jun. 29, 2017

(54) VEHICLE POSITIONING APPARATUS

(71) Applicant: Nuctech Company Limited, Beijing (CN)

(72) Inventors: Yuan HE, Beijing (CN); Qiangqiang WANG, Beijing (CN); Hongqi LI, Beijing (CN)

(21) Appl. No.: 15/281,020

(22) Filed: Sep. 29, 2016

(30) Foreign Application Priority Data
Dec. 28, 2015 (CN) 201510999042.5

(51) Int. Cl. F16M 11/22

(52) U.S. Cl. CPC F16M 11/22; F16M 2200/08

(57) ABSTRACT

The present disclosure relates to a vehicle positioning apparatus. An implementation may comprise a base provided with a recess, wherein each of two opposite sides of an upper edge of the recess are rotatably provided with a flap, and wherein a power unit may be provided on an outer side of a corresponding flap opposite to the recess. Further, the power unit may be adapted for driving the corresponding flap to transfer between a first supporting position and a second supporting position inclining downwardly, wherein the first supporting position is in a range from a position higher than the second supporting position to a position in a same plane as an upper surface of the base. Such vehicle positioning apparatus may achieve precise positioning of a whole vehicle, such as via the wheels of the vehicle, yielding high positioning accuracy, with simple structure, stable transmission, and low production cost.

### CROSS REFERENCE TO RELATED APPLICATION(S)

This application is based upon and claims benefit/priority of Chinese Patent Application No. 201510999042.5 filed on Dec. 28, 2015, published as ______, which are incorporated herein by reference in entirety.

### BACKGROUND

Technical Field

The present disclosure relates to a technical field of vehicle detection, and more particularly, to a vehicle positioning apparatus.

Description of Related Information

Generally, it is needed to check vehicles by radiation imaging in customs, airports, railways and the like, to ensure safety. During the check, it is necessary to position the vehicles at first, ensuring that the vehicles are located within a detection scope.

As shown in FIG. 1, an existing vehicle positioning apparatus generally positions a vehicle by a positioning block 1′ protruding from a travelling surface of the vehicle. In this apparatus, a motor reducer 2′ rotates to move a chain 3′ connected to an output end of the reducer. The chain 3′ rotates a shifting block, which moves the positioning block 1′ up and down along a slideway 4′.

However, when positioning the vehicles by the positioning block protruding from the vehicle travelling surface, a bounce will always happen to wheels when the wheels hit the positioning block, affecting a positioning accuracy adversely. Further, the structure of this vehicle positioning apparatus is complex with multiple transmission pairs, increasing failure rate adversely.

### OVERVIEW OF SOME ASPECTS

An aspect of the present disclosure is to provide a vehicle positioning apparatus with a high positioning accuracy, a simple structure and a stable transmission.

To achieve above aspect, the present disclosure provides following technical solutions:

A vehicle positioning apparatus, comprising a base provided with a recess, wherein each of two opposite sides of an upper edge of the recess is rotatably provided with a flap, a power unit is provided on an outer side of a corresponding flap opposite to the recess, and is adapted for driving the corresponding flap to transfer between a first supporting position and a second supporting position inclining downwardly, wherein the first supporting position is in a range from a position higher than the second supporting position to a position in a same plane as an upper surface of the base.

Further, the vehicle positioning apparatus further comprises a connecting member for each flap, an upper end of the connecting member is fixedly connected to a corresponding flap, and a lower end of the connecting member is rotatably connected to a retractable output shaft of the power unit corresponding to the same flap.

Further, the upper end of the connecting member is fixedly connected to a bottom surface of the corresponding flap.

Further, the connecting member and the corresponding flap are connected by welding.

Further, the power unit is a hydraulic cylinder.

Further, an end of the hydraulic cylinder opposite to the output shaft is connected to the base.

Further, the vehicle positioning apparatus further comprises a pumping station, for driving the output shaft of the hydraulic cylinder to retract or extend.

Further, an upper edge of the flap is rotatably connected to the base via a rotation shaft on the upper edge of the recess.

Further, the upper edge of the flap is connected to the rotation shaft by welding.

The advantages of the present disclosure is as follows:

The vehicle positioning apparatus provided by the present disclosure comprises a base provided with a recess, each of two opposite sides of an upper edge of the recess is rotatably provided with a flap, a power unit is provided outwardly from each flap, and is adapted for driving the flap to transfer between a first supporting position and a second supporting position inclining downwardly, wherein the first supporting position falls within a scope from a position higher than the second supporting position to a position in a same plane as an upper surface of the base. The vehicle positioning apparatus of the present disclosure achieves a precise positioning of a whole vehicle by positioning the wheels, and not only has a high positioning accuracy, a simple structure and a stable transmission, but also has a low production cost.

### BRIEF DESCRIPTION OF THE DRAWINGS

FIG. 1 is a structural diagram of a vehicle positioning apparatus in the prior art.

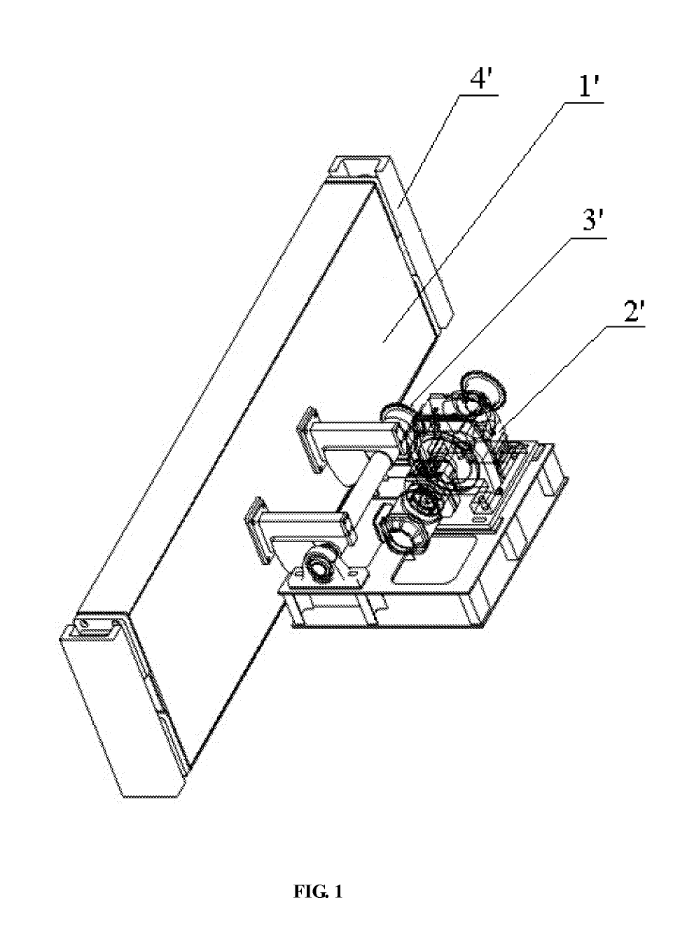

FIG. 2 is a perspective structural view of a vehicle positioning apparatus provided by the examples of the present disclosure.

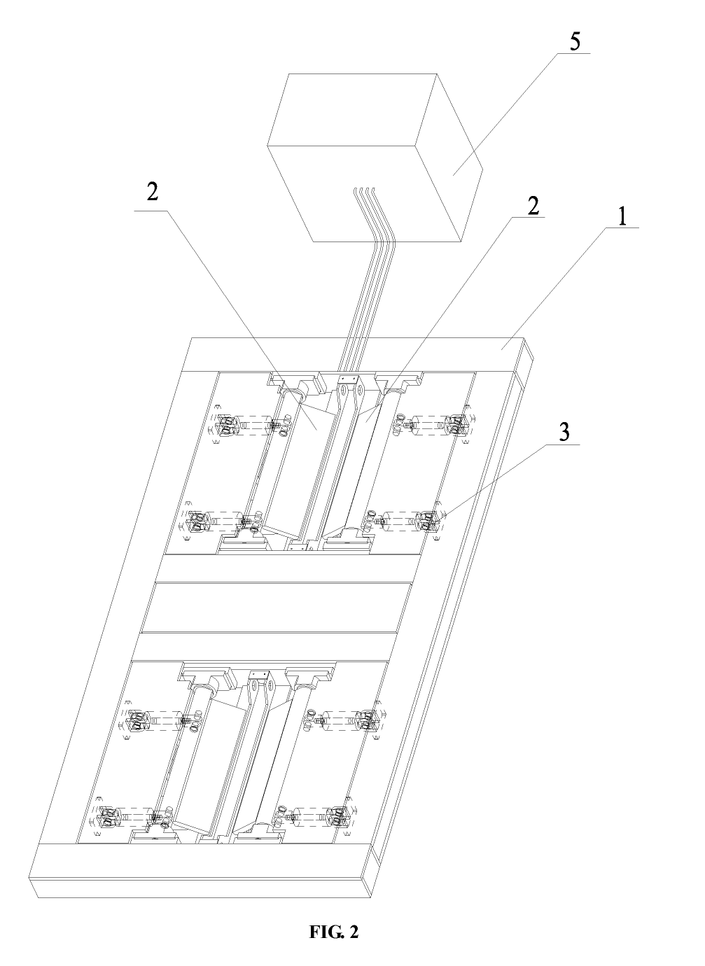

FIG. 3 is a top view of the vehicle positioning apparatus provided by the examples of the present disclosure.

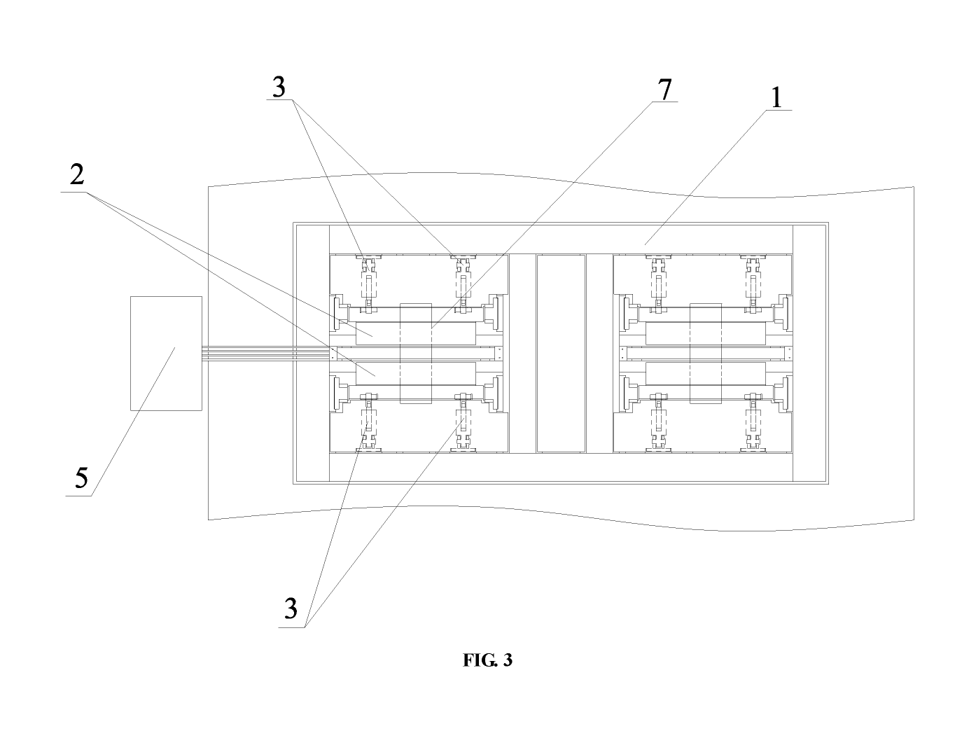

FIG. 4 is a structural diagram of the vehicle positioning apparatus provided by the examples of the present disclosure when the flap is turned down to a second supporting position for positioning a vehicle.

FIG. 5 is a structural diagram of the vehicle positioning apparatus provided by the examples of the present disclosure when the flap is located at a first supporting position at a same plane as an upper surface of the base.

FIG. 6 is a structural diagram of the vehicle positioning apparatus provided by the examples of the present disclosure when the flap is located at a first supporting position lower than an upper surface of the base.

FIG. 7 is a partial enlarged view of part A in FIG. 6.

### REFERENCE NUMBERS

1′, a positioning block; 2′, a motor reducer; 3′, a chain; 4′, a slideway; 1, a base; 2, a flap; 3, a power unit; 4, a connecting member; 5, a pumping station; 6, a rotation shaft; 7, a wheel; and 8, a support member.

### DETAILED DESCRIPTION OF ILLUSTRATIVE IMPLEMENTATIONS

The technical solution of the present disclosure will be further described in details by reference to the appended drawings and specific examples.

### Example

The example of the present disclosure provides a vehicle positioning apparatus as show in FIG s 2-6, including a base 1. The base 1 is provided with a recess and each of two opposite sides of an upper edge of the recess are rotatably provided with a flap 2. A power unit 3 is provided on an outer side of each flap 2 opposite to the recess, and the power unit 3 is adapted for driving a corresponding flap 2 to transfer between a first supporting position and a second supporting position inclining downwardly, wherein the first supporting position is in a range from a position higher than the second supporting position to a position in a same plane as an upper surface of the base 1.

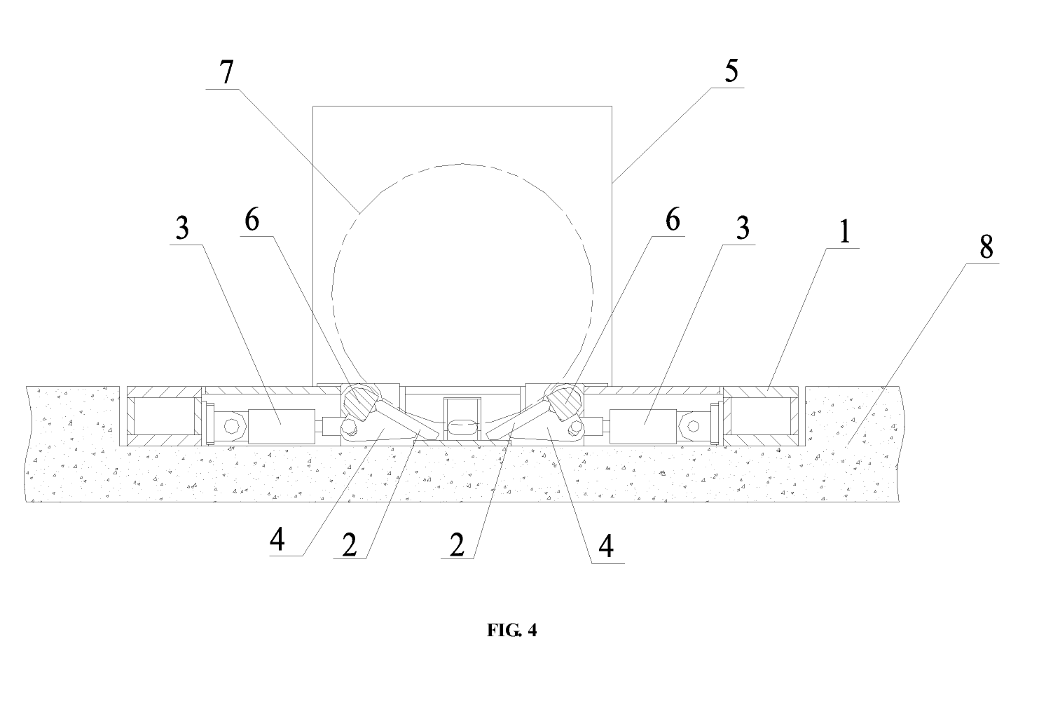

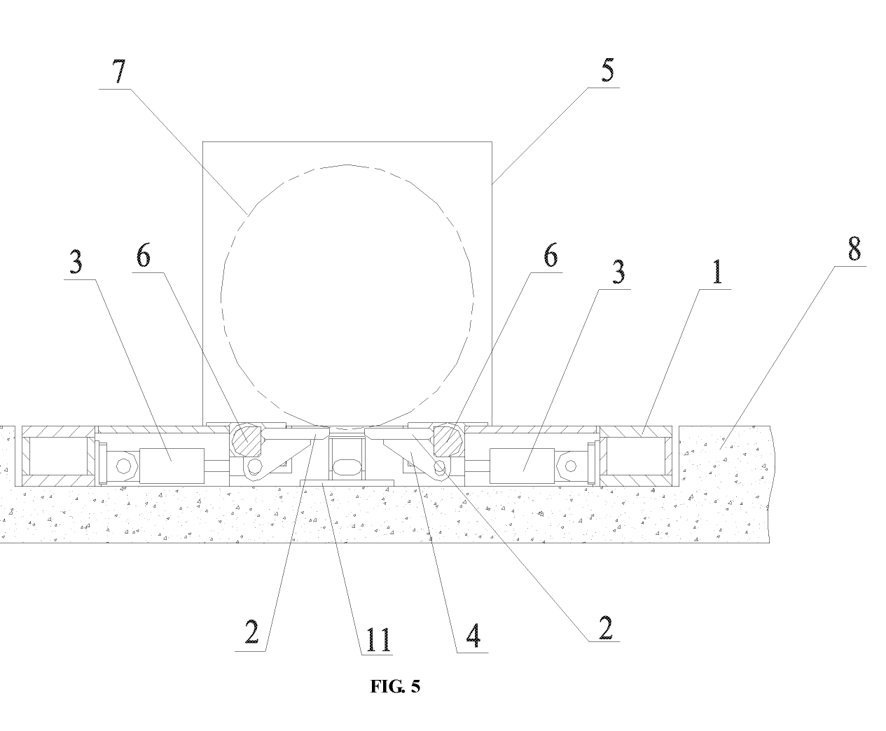

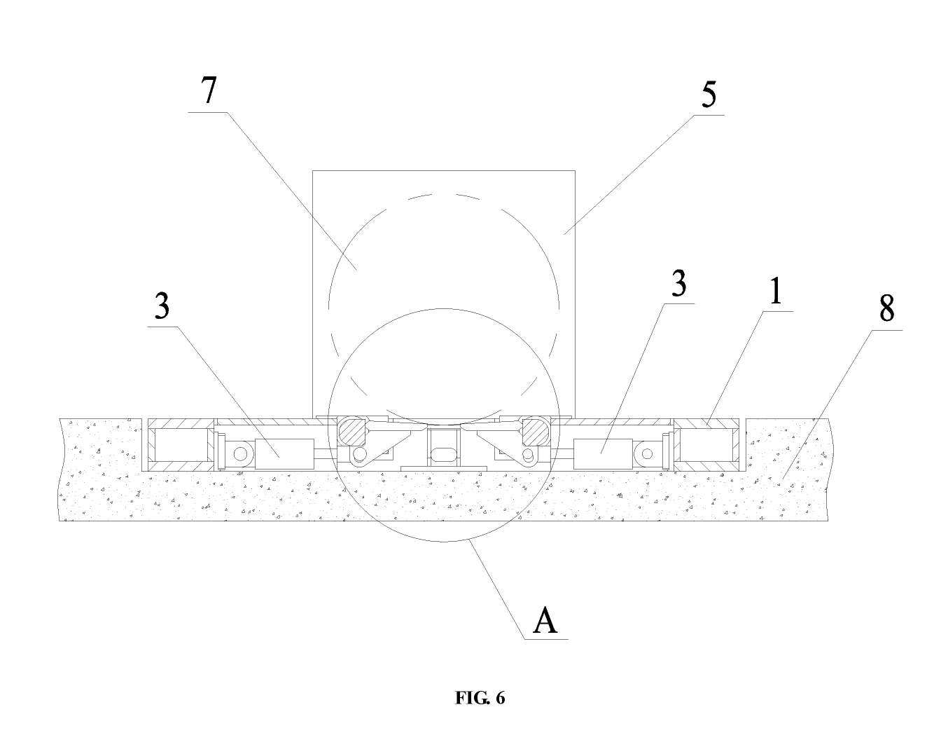

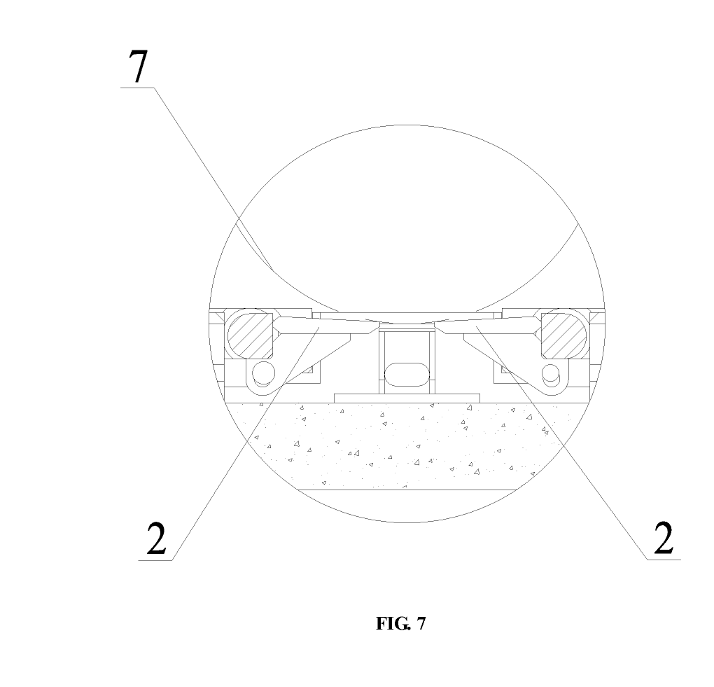

When positioning a vehicle, as shown in FIG. 4, the power units 3 drive their corresponding flaps 2 to be turned down to the second supporting position inclining downwardly, so that two flaps 2 constitute a positioning structure in a shape of V. At this state, if a wheel 7 of the vehicle moves into this positioning structure in the shape of V, the wheel 7 will sink. The driving can stop the vehicle when feeling the sink. In the case that the vehicle needs to move, as shown in FIG. 5, the power units 3 drive their corresponding flaps 2 to be turned up to the first supporting position in the same plane as the upper surface of the base 1, and uplifts the wheel 7, and then the vehicle can move away; alternatively, as shown in FIG. 6 and FIG. 7, the power units 3 drive their corresponding flaps 2 to be turned up to the position higher than the second supporting position and lower than the upper surface of the base 1, so that the two flaps 2 still can keep the shape of V, ensuring that the wheel 7 can pass without sliding. Preferably, the first supporting position is slightly lower than the upper surface of the base 1. The vehicle positioning apparatus provided in this example can achieve precise positioning of a vehicle by precisely positioning wheels of the vehicle. This vehicle positioning apparatus not only has a high positioning accuracy, a simple structure and a stable transmission, but also has a low production cost.

In this example, the base 1 is preferably provided with two recesses disposed oppositely to each other, and for each recess, the flaps and power units as described above are provided, so that two wheels 7 can be positioned at the same time. However, a number of the recesses is not limited to two, while can be specifically set according to the vehicles to be positioned.

In this example, preferably the flaps 2 provided on the two sides of the upper edge of the recess are respectively formed as a single piece of plate, while also can be constituted by at least two pieces of plate. Further, the vehicle positioning apparatus in this example can be applied to many situations where the vehicle positioning is needed. For example, the vehicle positioning apparatus in this example can be provided on a trailer for vehicle checking, and also can be provided on the ground. The vehicle positioning apparatus is preferably disposed in a recess provided in a support member 8 (for example, a body of the trailer or the ground), and can ensure that the flaps 2 are in a same plane as an upper surface of the support member except the recess, after the flaps 2 are turned up to the first supporting position which is in the same plane as the upper surface of the base 1.

As a more specific example, as shown in FIG. 4 and FIG. 5, the vehicle positioning apparatus further includes a connecting member 4 for each flap 2, wherein an upper end of the connecting member 4 is fixedly connected to a corresponding flap 2, and a lower end thereof is rotatably connected to a retractable output shaft of the power unit 3 corresponding to a same flap 2 with the connecting member 4. More specifically, the upper end of the connecting member 4 is fixedly connected to a bottom surface of the corresponding flap 2. However, the upper end of the connecting member 4 also can be fixedly connected to a side surface of the corresponding flap 2, as long as the connecting member 4 can drive the flap 2 to be turned up. Further, an angle between the connecting member 4 and the corresponding flap 2 determines a flapping angle of the corresponding flap 2, and can be set in advance according to size of wheels of the vehicle to be detected. In this example, the output shaft of the power unit 3 retracts or extends to drive the connecting member 4 corresponding to the same flap 2, so that the flap 2 can rotate. The structure is simple but has a reliable stability.

In this example, the number of the connecting members 4 connected to each flap 2 is not specifically limited, and can be set according to a type of the vehicle to be detected. But, preferably, at least two connecting members 4 shall be connected to each flap 2, to improve stability of the positioning apparatus. The connecting member 4 can be a plate-like structure, but not limited to this, as long as the connecting member 4 can drive the corresponding flap 2 to be turned up or down. In this example, the power unit 3 drives the corresponding flap 2 to be turned up or down by connecting with the connecting member 4 corresponding to the same flap 2. Therefore, it is preferable that the power units 3 respectively provided on the outer side of the two flaps 2 opposite to the recess have the same amount and are symmetrical, to improve the stability of the positioning apparatus. Further, the number of the power units 3 on the outer side of the corresponding one of the two flaps 2 opposite to the recess is preferably the same as the number of the connecting members 4 connected to the same flap 2, that is, each power unit 3 drives one connecting members 4. But alternatively, the power units 3 respectively provided on the outer side of the two flaps 2 opposite to the recess also can be asymmetrical, and each power unit 3 can correspond to more than one connecting members 4.

More specifically, a hydraulic cylinder can be used for the above-mentioned power units 3, and preferably, an end of the hydraulic cylinder opposite to the output shaft thereof is connected to the base 1, to improve the stability and positioning accuracy of the vehicle positioning apparatus.

Moreover, the above-mentioned vehicle positioning apparatus further includes a pumping station, for driving the output shaft of the hydraulic cylinder to retract or extend.

More specifically, an upper edge of the flap 2 is rotatably connected to the base 1 via a rotation shaft 6 on the upper edge of the recess. At least one of the connections between the upper end of the flap 2 and the rotation shaft 6, and between the connecting member 4 and the corresponding flap 2 is achieved by welding, to ensure the stability of the positioning apparatus and to reduce the production cost.

The technical principle of the present invention is described by referring to the specific examples above. These descriptions are intended to illustrate certain principles of the present disclosure, and not to limit the protective scope of the present disclosure and/or innovations in any manner. Other specific examples that can be thought of by those skilled in the art without spending creative labors also will fall within the protective scope of the present disclosure and inventions.

1. A vehicle positioning apparatus, the apparatus comprising:
a base provided with a recess, wherein each of two opposite sides of an upper edge of the recess are rotatably provided with a flap, and
a power unit provided on an outer side of a corresponding flap opposite to the recess, the power unit adapted for driving the corresponding flap to transfer between a first supporting position and a second supporting position inclining downwardly,
wherein the first supporting position is in a range from a position higher than the second supporting position to a position in a same plane as an upper surface of the base.

2. The vehicle positioning apparatus according to claim 1, wherein the vehicle positioning apparatus further comprises a connecting member for each flap,
wherein an upper end of the connecting member is in fixed connection to a corresponding flap, and
wherein a lower end of the connecting member is rotatably connected to a retractable output shaft of the power unit corresponding to the same flap.

3. The vehicle positioning apparatus according to claim 2, wherein the upper end of the connecting member is in fixed connection to a bottom surface of the corresponding flap.

4. The vehicle positioning apparatus according to claim 2, wherein the connecting member and the corresponding flap are connected by welding.

5. The vehicle positioning apparatus according to claim 2, wherein the power unit is a hydraulic cylinder.

6. The vehicle positioning apparatus according to claim 5, wherein an end of the hydraulic cylinder opposite to the output shaft is connected to the base.

7. The vehicle positioning apparatus according to claim 6, wherein the vehicle positioning apparatus further comprises a pumping station, for driving the output shaft of the hydraulic cylinder to retract or extend.

8. The vehicle positioning apparatus according to claim 1, wherein an upper edge of the flap is rotatably connected to the base via a rotation shaft on the upper edge of the recess.

9. The vehicle positioning apparatus according to claim 6, wherein the upper edge of the flap is connected to the rotation shaft by welding.

10. The vehicle positioning apparatus according to claim 2, wherein an angle between the connecting member and the flap defines an angle between the first supporting position and the second supporting position.

11. The vehicle positioning apparatus according to claim 1, further comprising a support member, which comprises a receiving portion for receiving the base, and an upper surface of the base is in a same plane as that of the support member.

12. The vehicle positioning apparatus according to claim 3, wherein the power unit is a hydraulic cylinder.

13. The vehicle positioning apparatus according to claim 12, wherein an end of the hydraulic cylinder opposite to the output shaft is connected to the base.

14. The vehicle positioning apparatus according to claim 13, wherein the vehicle positioning apparatus further comprises a pumping station, for driving the output shaft of the hydraulic cylinder to retract or extend.

15. The vehicle positioning apparatus according to claim 14, wherein an upper edge of the flap is rotatably connected to the base via a rotation shaft on the upper edge of the recess.

16. The vehicle positioning apparatus according to claim 15, wherein an angle between the connecting member and the flap defines an angle between the first supporting position and the second supporting position.

17. The vehicle positioning apparatus according to claim 16, further comprising a support member, which comprises a receiving portion for receiving the base, and an upper surface of the base is in a same plane as that of the support member.

18. The vehicle positioning apparatus according to claim 7, wherein an upper edge of the flap is rotatably connected to the base via a rotation shaft on the upper edge of the recess.

19. The vehicle positioning apparatus according to claim 18, wherein an angle between the connecting member and the flap defines an angle between the first supporting position and the second supporting position.

20. The vehicle positioning apparatus according to claim 19, further comprising a support member, which comprises a receiving portion for receiving the base, and an upper surface of the base is in a same plane as that of the support member.
